(19) United States
(12) Patent Application Publication
(10) Pub. No.: US 2020/0290895 A1
(43) Pub. Date: Sep. 17, 2020

(54) SYSTEM AND APPARATUS FOR CONDITIONING WATER AND REGNERERATING ION EXCHANGE RESIN

(71) Applicant: Tygrus, LLC, Troy, MI (US)

(72) Inventors: Steven Mosher, Troy, MI (US); Lawrence Carlson, Troy, MI (US); Andrew M. Yaksic, Brighton, MI (US)

(73) Assignee: Tygrus, LLC, Troy, MI (US)

(21) Appl. No.: 16/818,002

(22) Filed: Mar. 13, 2020

Related U.S. Application Data
(60) Provisional application No. 62/819,488, filed on Mar. 15, 2019.

(51) Int. Cl. C02F 1/42; B01J 49/75

(52) U.S. Cl. CPC C02F 1/42; B01J 49/75; C02F 2209/001; C02F 2201/002; C02F 2001/425

(57) ABSTRACT

A method for regeneration of an ion exchange material employed in a water softening or conditioning system that includes the step of contacting the ion exchange material with an aqueous process fluid to yield a regenerated ion exchange material, wherein the ion exchange material has at least one target material associated therewith. The target material includes at least one of the following: metal ions such as those that have been extracted from a source of hard water, ionically soluble organic compounds, active water borne pathogens. The aqueous process fluid comprises a compound having the general formula:

$$⌊ {H}_{x} {O}_{\frac{( x - 1 )}{2}} ⌋ {Z}_{y}$$

wherein x is an odd integer ≥3;
wherein y is an integer between 1 and 20; and
wherein Z is a polyatomic ion, a monoatomic ion, or a mixture of a polyatomic ion and a monoatomic ion;
   during the contacting step, at least a portion of the target material associated with the ion exchange material is removed from association with the ion exchange material. After removal from association with the ion exchange material, the target material can be retained in the process fluid and conveyed to a suitable recovery and/or removal source as desired or required.

The present application is a non-provisional United Sates utility application that claims the benefit and priority to U.S. Provisional Application No. 62/819,488 filed Mar. 15, 2019, the specification of which is incorporated by reference herein in its entirety.

### BACKGROUND

The disclosure relates to water treatment. More particularly, this disclosure relates to systems and apparatus of regenerating ion exchange resins and materials employed in water treatment processes and operations

Use of raw water containing hardness causing elements in various household uses, in industrial application such as boiler feed water or for various other uses can cause substantial damage to equipment as well as requiring frequent cleaning operations. Additionally, in various household uses, raw water containing hardness can interfere with the efficiency of soaps and detergents and can impart undesirable taste to the water used .

The total hardness of a water is generally understood in the art to be caused by the combined concentrations of calcium and magnesium salts present in the water. This value is usually expressed as parts per million (ppm) calcium carbonate. The damage and cleaning problems caused by high concentrations of such materials in water supplies are quite undesirable in domestic situation and can be expensive to commercial operations both in down time and in cost to replace equipment. In terms of operating and investment costs, it is desirable and many times economical to treat raw feed water to remove hardness and alkalinity prior to introducing it into equipment.

Water softeners are used to remove hardness from water via ion exchange. On drawback to such operations is that on-site regeneration requires the use of salt as the ion exchange regenerant. In many municipalities the use of salt for brine regeneration is being curtailed due to the impact of sodium chloride on bioreactors located at the municipal treatment facility. In order to address this problem, the use of bottle exchange tanks can be employed. These systems are an expensive alternative to on-site regeneration. Thus, it would be desirable to provide a system and method for regenerating ion exchange resin that can be used for in situ regeneration if desired or required.

### SUMMARY

A systems that implements a method for regeneration of an ion exchange material employed in a water softening or conditioning system in which the ion exchange material with an aqueous process fluid to yield a regenerated ion exchange material by the removal of at least one target material in which the aqueous process fluid comprises a compound having the general formula:

$$⌊ {H}_{x} {O}_{\frac{( x - 1 )}{2}} ⌋ {Z}_{y}$$

wherein x is an odd integer ≥3;
wherein y is an integer between 1 and 20; and
wherein Z is a polyatomic ion, a monoatomic ion, or a mixture of a polyatomic ion and a monoatomic ion;
   during the contacting step, at least a portion of the target material associated with the ion exchange material is removed from association with the ion exchange material. After removal from association with the ion exchange material, the target material can be retained in the process fluid and conveyed to a suitable recovery and/or removal source as desired or required. The target material that is removed from the ion exchange material includes at least one of the following: metal ions such as those that have been extracted from a source of hard water, ionically soluble organic compounds, active water borne pathogens.

In certain situations, the target material can include metal cations that are extracted from hard water such as magnesium and/or calcium. Other metal cations can be included in the target material depending on the aqueous stream to be treated.

The system comprises at least two treatment vessels, the treatment vessels each having a water inlet and a water outlet, each regeneration vessel having an interior region containing ion exchange resin, and an controller in electronic communication with the at least two treatment vessels, the electronic controller configured to alternately direct supply water to be conditioned or aqueous process fluid to a respective treatment vessel.

### BRIEF DESCRIPTION OF THE DRAWING

The various features, advantages and other uses of the present apparatus will become more apparent by referring to the following detailed description and drawing in which:

FIG. 1 is a schematic diagram of an embodiment of the for treatment of water and regeneration of an ion exchange material employed in a water softening or conditioning system as disclosed herein.

### DETAILED DESCRIPTION

Disclosed herein is a system for treatment of water and regeneration of an ion exchange material in a water softening or conditioning system that includes at least two treatment vessels, each treatment vessel having a housing, the housing having at least one water inlet and at least one water outlet and an interior cavity and an ion exchange material contained therein. The system also includes at least one controller in electronic communication with the at least two treatment vessels, the electronic controller configured to alternately direct supply water to be conditioned or aqueous process fluid to a respective treatment vessel as well as at least one first storage vessel system in fluid communication with the at least two treatment vessels, the at least one first storage vessel system containing an aqueous process and at least one second storage vessel system containing a volume of supply water. The aqueous process fluid contains water and a compound having he general formula:

$$⌊ {H}_{x} {O}_{\frac{( x - 1 )}{2}} ⌋ {Z}_{y}$$

wherein x is an odd integer ≥3;
wherein y is an integer between 1 and 20; and
wherein Z is a polyatomic ion, a monoatomic ion, or a mixture of a polyatomic ion and a monoatomic ion;

The system can be employed to implement a process or method that includes the step of contacting the ion exchange material having at least one target material associated therewith with the aqueous process fluid to yield a regenerated ion exchange material. In which at least a portion of the target material has been removed from association with the ion exchange resin . The aqueous process fluid comprises a compound having the general formula:

$$⌊ {H}_{x} {O}_{\frac{( x - 1 )}{2}} ⌋ {Z}_{y}$$

wherein x is an odd integer ≥3;
wherein y is an integer between 1 and 20; and
wherein Z is at least one polyatomic ion, at least one monoatomic ion, or a mixture of at least one polyatomic ion and at least one monoatomic ion

The ion exchange material to be regenerated can be any suitable ion exchange resin or other that includes at least one target material that is associated with the ion exchange material. The target material can be one or more compounds that one that are found in a water softening or conditioning stream. The target material is one which is to be removed in whole or in part and can include, but is not limited to, at least one of metal ions, ionically soluble organic compounds, active water-borne pathogens, and the like.

The target material can be one that is maintained in contact with the ion exchange material either by bonding or affinity. During the contacting step as disclosed herein, at least a portion of the target material is dissociated from the ion exchange resin material and transferred to and removed by the aqueous process fluid. The contacting step can continue for an interval sufficient to achieve release of at least a portion of the target material from association with the ion exchange material. In certain embodiments, the contact interval between the aqueous process fluid and the ion exchange material can be between two minutes and five hours. In certain embodiments, the contact interval can be between the aqueous process fluid and the ion exchange material can be between five minutes and five hours. In certain embodiments, the contact interval can be between the aqueous process fluid and the ion exchange material can be between two minutes and 45 minutes. In certain embodiments, the contact interval can be between the aqueous process fluid and the ion exchange material can be between five minutes and 45 minutes. In certain embodiments, the contact interval can be between the aqueous process fluid and the ion exchange material can be between two minutes and 30 minutes. minutes. In certain embodiments, the contact interval can be between the aqueous process fluid and the ion exchange material can be between two minutes and 20 minutes. In certain embodiments, the contact interval can be between the aqueous process fluid and the ion exchange material can be between five minutes and five hours. In certain embodiments, the contact interval can be between the aqueous process fluid and the ion exchange material can be between 10 minutes and two hours

The contact between the aqueous process fluid and the ion exchange material can occur at a temperature between 10° and 30° in certain situations. It is also considered with in the purview of the present disclosure that the contacting step can occur at elevated temperatures where desired or required. It is also within the purview of this disclosure that the contact step can occur at an elevated temperature with the elevated temperature limits being ones that are limited by the thermal degradation temperature of the associated ion exchange resin being treated. In certain embodiments, the contact between the aqueous process fluid and the ion exchange material can occur at a temperature between 10° and 60° C. in certain situations where the ion exchange resin is an anion exchange resin material and between 10° and 130° C. in certain situations where the ion exchange material is a cation exchange resin material.

Where elevated temperatures are employed in the contacting step, the temperature elevation can be accomplished by heating the aqueous process fluid to an elevated temperature sufficient to achieve an elevated temperature such as a temperature during contact that is within a desired range such as those defined above. Heating of the process fluid can occur by any suitable heat transfer mechanism. In certain methods, the aqueous process fluid can be heated to a temperature greater than the thermal degradation temperature limits associated with the specific ion exchange material to be treated as when thermal cooling can be accomplished by dilution and/or thermal transfer prior to or upon coming into contact with the ion exchange material.

The ion exchange material that can be treated by the method disclosed herein can be an organic compound, an inorganic compound or a mixture o the two that facilitates the removal of a target material from a water stream and association of the target material with the ion exchange material. The target material tat is removed from the water stream can be one or more of the following: of metal ions, ionically soluble organic compounds, active water-borne pathogens.

In many use applications, the ion exchange resin can be a compound or combination of compounds that removes materials such as calcium, magnesium as well as other metal cations from at least one high mineral content water source or stream (commonly called hard water) in a process commonly referred to a water softening. The hardness of water is typically determined by the concentration of multivalent cations present in the water. As used herein the term multivalent cations is defined as metal complexes having a charge greater than 1+. In many situations, the multivalent cations will have a charge of 2+. The metal cations present in the water stream to be treated can include but are not limited to cations such as Ca²⁺, Mg²⁺. It is also considered within the purview of the present disclosure that the water stream to be conditioned can include ions of elements such as such as barium, radium, strontium, iron, aluminum, manganese, and the like.

Because the precise mixture of metals dissolve in water together with the water's pH and temperature determine the behavior of the water hardness is difficult to quantify in a single number. However, the US Geological Survey provides the following classification scheme set forth in Table 1.

TABLE I

| | Hardness | | | | |
|---|---|---|---|---|---|
| Class- | (mg- | Hardness | Hardness | Hardness | Hardness |
| ification | CaCO3/L) | (mmol/L) | (dGH/°dH) | (gpg) | (ppm) |
| Soft | 0-60 | 0-0.60 | 0-3.37 | 0-3.50 | 0-60 |
| Moderately | 61-120 | 0.61-1.20 | 3.38-6.74 | 3.56-7.01 | 61-120 |
| Hard | | | | | |
| Hard | 120-180 | 1.21-1.80 | 6.75-10.11 | 7.06-10.51 | 121-180 |
| Very Hard | ≥181 | ≥1.81 | ≥10.12 | ≥10.57 | ≥181 |

Non-limiting examples of ion exchange resin that can be regenerated or recharged by the method disclosed herein include but are not limited to polymeric ion exchange resin materials, and inorganic materials such as zeolite. The polymeric ion exchange resin can be in any suitable physical form including but not limited to beads, membranes and the like.

Non-limiting examples of suitable polymeric ion exchange resins that can be treating according to the method disclosed herein include weakly acidic cation exchange resin, strongly acidic cation exchange resin, zeolites, and the like.

Without being bound to any theory, it is believed that weakly acidic cation exchange resin that can be treated by the method disclosed herein can be composes in whole or in part of material composed of acrylic or methacrylic acid that has been cross-linked with a di-functional monomer such as divinylbenzene. In certain materials the synthesis process that yields the ion exchange resin can begin with an ester of the acid in suspension polymerization followed by hydrolysis of the resulting product to produce the functional acid group. The resulting resin material may be one that has a polyacrylic backbone and a plurality of functional carboxylic groups attached to the backbone.

Weakly acidic cation exchange resins have a high affinity for the hydrogen ion and can be regenerated with strong inorganic acids. The acid-regenerated resin can exhibit a high capacity of alkaline earth metals such as calcium and magnesium and for alkali metals associated with alkalinity. It has been found, quite unexpectedly, that weakly acidic cation exchange resins can be regenerated by exposure to the process fluid material disclosed herein. Without being bound to any theory, it is believed that the process fluid disclosed herein displaces metal ions associated with the ion exchange material and provides a source of hydrogen ions that replaces the displaced metal ions with hydrogen ions, particularly in weakly acidic cation exchange material.

It is believed that strong acid cation resin can be cross-linked polystyrene sulfonate compounds. Non-limiting examples of strongly acidic cation resin material include polystyrene resins that can include up to 15% divinylbenzene. Without being bound to any theory, it is believed that the process fluid material provides a hydrogen source that can displace metal ions that are associated with the strong acid cation resin and can provide a source of hydrogen ions that replace the hydrogen ions in strongly acidic cation resin material.

Where desired or required, the ion exchange material can be composed in whole or in part of an inorganic material such as zeolite.

During the contacting step, the aqueous process fluid can be brought into contact with the ion exchange resin in any suitable manner. In certain embodiments, a process stream in introduced in to contact with a bed of ion exchange material held in fixed or partially fixed relationship. The process fluid can be introduced into contact with the ion exchange material in a manner that facilitates removal or dissociation of the target material and transport of the process fluid away from the ion exchange material by a process such as elution.

Where desired or required, the contacting step can be achieved by various processes including but not limited to co-flow regeneration processes, counter-flow regeneration processes, packed bed regeneration and the like.

As used herein co-current or co-flow regeneration processes include processes in which a fixed quantity of ion exchange material, typically contained in the suitable vessel, is regenerated by the introduction of the aqueous process fluid as disclosed herein into contact with the ion exchange resin material in the same direction as the service flow (downwards). Where desired or required, the process can also include a backwashing step that can be carried out to remove suspended solids and resin fines.

As used herein counter-flow or counter-current regeneration processes include processes in which a fixed quantity of ion exchange material, typically contained in the suitable vessel, is regenerated by the introduction of the aqueous process fluid as disclosed herein by the introduction of the aqueous process fluid as disclosed herein into contact with the ion exchange material in a counter a direction opposed to the service flow.

Blocked bed systems include systems in which the bed of ion exchange material is held down by air, water or a suitable inert material or mass. Typically, service flow is in a downward direction and introduction of the aqueous process fluid is introduced as up flow.

Packed bed systems are systems in which the bed is maintained in position with an up-flow of service fluid and a downflow of the aqueous process fluid or vice versa.

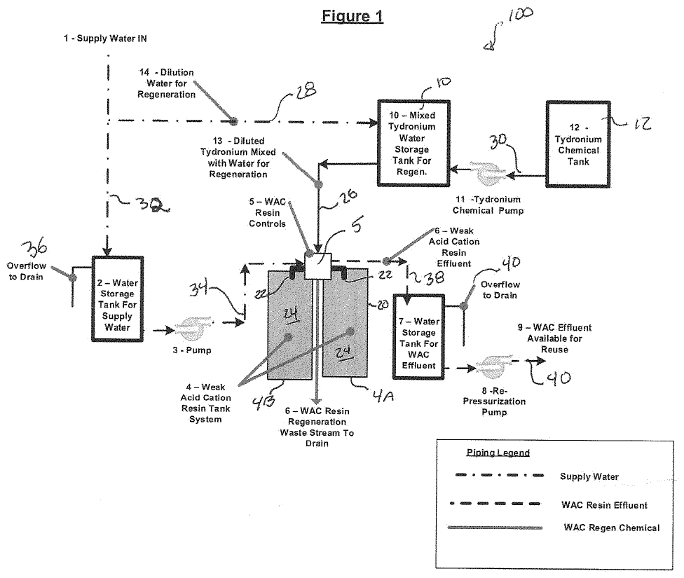

On non-limiting embodiment of a system 100 for treatment of water and regeneration of an ion exchange material employed in a water softening or conditioning system is depicted in FIG. 1. The system 100 as depicted in FIG. 1 includes at least two treatment vessels 4A and 4B. The system 100 can be configured such that the at least two treatment vessels 4A, 4B can operate in series or in parallel as desired or required. It is contemplated that the system can be configured to permit one treatment vessel 4A or 4B can be online functioning to condition, treat or soften water as desired or required while the other vessel is offline being regenerated as desired or required.

The at least two treatment vessels 4A, 4B each have a housing 20. The housing 20 can have at least one water inlet 22 and at least one water outlet (not shown) defined therein. Where desired or required, as in bottle treatment systems, the water inlet and outlet can be unitary. Each housing 20 defines an interior cavity 24 that contains a quantity of ion exchange material. In the embodiment depicted the ion exchange material can be in the form of beads or granules. In certain embodiments, the ion exchange resin can be weak acid cation resin. In its spent state, the weak acid cation resin to be regenerated can have at least one target material associated therewith. The target material can be one selected from the group consisting of metal ions, water soluble organic compounds biological pathogens and mixtures thereof.

The system 100 also includes at least one controller 5. The at least one electronic controller 5 is in electronic communication with the at least two treatment vessels. The electronic controller is configured to direct supply water to be conditioned or an aqueous process fluid to at least one of the treatment vessels 4A, 4B in suitable sequence.

The system 100 also includes at least one first storage vessel 10 that is in fluid communication with the at least two treatment vessels 4A, 4B. The at least one storage vessel 10

In regeneration mode, one or more of the at least two treatment vessels 4A, 4B are in fluid communication with the at least one first storage vessel 10. The at least on first storage vessel 10 is configured to contain aqueous process fluid for introduction into the at desired treatment vessel through a suitable conduit such as conduit. In the embodiment of the system 100 as depicted in FIG. 1, the aqueous process fluid is conveyed to the at least two treatment vessels 4A, 4B through conduit 26. Where desired or required, the at least one controller 5 is in communication with the conduit 26.

The at least one first storage vessel 10 is in fluid communication with water supply line 28 and with a compound storage tank 12 via conduit 30. Where desired or required, conduit 30 can include a suitable pump device 11 configured to convey a compound such as defined herein into the at least one first storage vessel 10. Without being bound to any theory, it is believed that the compound as defined herein is commercially available under the tradename TYDRONIUM. Where desired or required, the at least one first storage tank 12 can include suitable mixing and metering devices (not shown). Where desired or required, the first storage tank 12 may also include various sensors and monitoring devices (not shown) including but not limited to pH and the like. Collectively, the at least one first storage vessel 10, conduit 30 and compound storage tank 12 can be referred to as a first storage vessel system.

The system 100 can also include at least one second storage vessel system that is in communication with the at least two treatment vessels 4A, 4B. The at least one second storage vessel system can include at least one supply water storage tank 2. The at least one storage tank 2 includes at least one fluid inlet and in communication with a suitable conduit 32 to convey supply water from a supply water source to the at least one storage tank 2. The at least one storage tank 2 also includes at least one fluid outlet in fluid communication with the at least two treatment vessels 4A, 4B as by conduit 34. Where desired or required, the conduit 34 can include a pump 3 to assist conveyance of supply water to the at least two treatment vessels 4A, 4B. The at least one storage tank 2 can also include auxiliary devices such as sensors, monitors (not shown) and devices such as overflow spigot 36 that can communicate to a drain (not shown).

During the regeneration process, waste produced during the ion exchange material regeneration procedure can be conveyed to a suitable drain or holding tank (not shown) by way of conduit 8. Ion exchange material regeneration effluent containing the water, TYDRONIUM and target material dissociated from the ion exchange material during regeneration is conveyed away from the at least two treatment vessels 4A, 4B as through conduit 6 to a suitable process fluid effluent tank 7. Where desired or required, the effluent tank 7 can be equipped with suitable sensors, monitors and the like (not shown). The effluent tank 7 can also include devices such as a overflow spigot 40. The device 100 can also include a suitable conduit 40 to convey aqueous process fluid for reconditioning and reuse.

Where desired or required, the aqueous process fluid can include one or more additional component including metal cheating agents and the like. Non-limiting examples of suitable metal cheating agents include sodium nitrate, potassium nitrate, sodium succinate, potassium succinate, aspartate, maleate, ethylenediamine tetraacetate, ethylene glycol tetraacetate, polymerized amino acids, 1,2-bis(o-aminophenoxy)ethane-N,N,N′,N′-tetraacetate, sulfonated polycarboxylate copolymers, polymethacrylate and the like. The amount of metal cheating agent can be present in an amount sufficient to sequester at least a portion of the metal cations displaced from contact with the ion exchange material. In certain embodiments, it is contemplated that the cheating agent can be present in an amount between 0.001vol % and 10 vol % of the aqueous process fluid. In certain embodiments, the metal cheating agent selected from the group consisting of sodium nitrate, potassium nitrate, sodium succinate, potassium succinate, aspartate, maleate, ethylenediamine tetraacetate, ethylene glycol tetraacetate, polymerized amino acids, 1,2-bis(o-aminophenoxy)ethane-N,N,N′,N′-tetraacetate, sulfonated polycarboxylate copolymers, polymethacrylate, and mixtures thereof.

As broadly disclosed herein, the aqueous process fluid comprises:

between 0.001 vol % and 50 vol % of a compound having the general formula:

$$⌊ {H}_{x} {O}_{\frac{( x - 1 )}{2}} ⌋ {Z}_{y}$$

wherein x is an odd integer ≥3;
wherein y is an integer between 1 and 20; and
wherein Z is at least one polyatomic ion, at least one monoatomic ion, or a mixture of at least one polyatomic ion and at least one monoatomic ion; and water.

The compound as disclosed herein can be construed as oxonium ion-derived complex. As defined herein “oxonium ion complexes” are generally defined as positive oxygen cations having at least one trivalent oxygen bond. In certain embodiments, the oxygen cation will exist in aqueous solution as a population predominantly composed of one, two and three trivalently bonded oxygen cations present as a mixture of the aforesaid cations or as material having only one, two or three trivalently bonded oxygen cations. Non-limiting examples of oxonium ions having trivalent oxygen cations can include at least one of hydronium ions.

It is contemplated that the in certain embodiments the oxygen cation will exist in aqueous solution as a population predominantly composed of one, two and three trivalently bonded oxygen anions present as a mixture of the aforesaid anions or as material having only one, two or three trivalently bonded oxygen anions.

In the aqueous process fluid as disclosed herein it is contemplated that tat least portion of the compound is present as hydronium ions, hydronium ion complexes and mixtures of the same. Suitable cationic materials in the compound can also be referred to as hydroxonium ion complexes and can provide the aqueous process fluid with an effective pH less than 6 in certain application and an effective pH below 5 in others.

When in the aqueous process fluid, the compound will function as a stable hydronium material that will remain identifiable. It is believed that the stable hydronium material disclosed herein can complex with water molecules to form hydration cages of various geometries, non-limiting examples of which will be described in greater detail subsequently. The stable electrolyte material as disclosed herein, when introduced into a polar solvent such as an aqueous solution is stable and can be isolated from the associated solvent as desired or required.

Conventional strong organic and inorganic acids such as those having a pKₐ≥1.74, when added to water, will ionize completely in the aqueous solution. The ions so generated will protonate existing water molecules to form H₃O+ and associate stable clusters. Weaker acids, such as those having a pKₐ<1.74, when added to water, will achieve less than complete ionization in aqueous solution but can have utility in certain applications. Thus, it is contemplated that the acid material employed to produce the stable electrolyte material can be a combination of one or more acids. In certain embodiments, the acid material will include at least one acid having a pKₐ greater than or equal to 1.74 in combination with weaker acids(s).

In the present disclosure, it has been found quite unexpectedly that the stable hydronium electrolyte material as defined herein, when present in the aqueous solution, will produce a polar solvent and provide an effective pKₐ which is dependent on the amount of stable hydronium electrolyte material added to the corresponding solution independent of the hydrogen ion concentration originally present in that solution. The resulting solution can have an effective pKₐ between 0 and 5 in certain applications when the initial solution pH prior to addition of the stable hydronium material is between 6 and 8.

It is also contemplated that the stable electrolye material as disclosed herein can be added to aqueous material having an initial pH in the alkaline range, for example between 8 and 12 to effectively adjust the pH of the resulting solvent and/or the effective or actual pKₐ of the resulting solution. Addition of the stable electrolyte material as disclosed herein can be added to an alkaline solution without perceivable reactive properties including, but not limited to, exothermicity, oxidation or the like.

The stable hydronium material as disclosed herein, provides a source of concentrated hydronium ions that are long lasting and can be subsequently isolated from solution if desired or required.

In certain embodiments, the aqueous process fluid can include a compound having the formula:

$$[ {H}_{x} {O}_{\frac{( x - 1 )}{2}} + {( {H}_{2} O )}_{y} ] Z$$

wherein x is an odd integer between 3-11;
y is an integer between 1 and 10; and
Z is a polyatomic or monoatomic ion.

The polyatomic ion Z can be an ion that is derived from an acid having the ability to donate one or more protons. The associated acid can be one that would have a pKₐ values≥1.7 at 23° C. . The polyatomic ion Z employed can be one having a charge of +2 or greater. Non-limiting examples of such polyatomic ions include sulfate ions, carbonate ions, phosphate ions, oxalate ions, chromate ions, dichromate ions, pyrophosphate ions and mixtures thereof. In certain embodiments, it is contemplated that the polyatomic ion can be derived from mixtures that include polyatomic ions that include ions derived from acids having pKₐ values≤1.7.

In certain embodiments, the compound as disclosed herein can provide an effective concentration of stable hydronium ion material that present at a concentration between 10 ppm and 1000 ppm and in certain embodiments, the compound will be present at a concentration greater than between 100 ppm and 2000 ppm when admixed with a suitable aqueous or organic solvent. It is also contemplated that the compound will be present in an amount between 1000 ppm and 10000 ppm in certain embodiments, while in other embodiments, the compound can be present in concentrations between 0.5 vol % and 15 vol %

It has been found, quite unexpectedly, that the hydroniun ion complexes present in solution as a result of presence of the compound as disclosed herein can result in an aqueous process fluid having an altered acid functionality without a concomitant change in the free acid to total acid ratio. The alteration in acid functionality can include characteristics such as change in measured pH, changes in free-to-total acid ratio, changes in specific gravity and rheology. Changes in spectral output and chromatography output are also noted as compared to the incumbent acid materials used in production of the stable electrolyte material containing the initial hydronium ion complex. Addition of the stable electrolyte material as disclosed herein results in changes in pKₐ which do not correlate to the changes observed in free-to-total acid ratio.

Thus, the aqueous process fluid as disclosed herein can have an effective pKₐ between 0 to 5. It is also to be understood that pKₐ of the resulting solution can exhibit a value less than zero as when measured by a calomel electrode, specific ion ORP probe. As used herein the term “effective pKₐ” is a measure of the total available hydronium ion concentration present in the resulting solvent. Thus, it is possible that pH and/or associated pKa of a material when measured may have a numeric value represented between −3 and 7. It is believed that the compound present in the aqueous process fluid as disclosed herein can facilitates at least partial coordination of hydrogen protons with the hydronium ion electrolyte material and/or its associated lattice or cage. As such, the introduced stable hydronium ion electrolyte material exists in a state that permits selective functionality of the introduced hydrogen associated with the hydrogen ion.

It is contemplated that at least a portion of the compound present in the aqueous composition as disclosed herein can have the general formula:

$$⌊ {H}_{x} {O}_{\frac{( x - 1 )}{2}} ⌋ {Z}_{y}$$

x is an odd integer ≥3;
y is an integer between 1 and 20; and
Z is one of a monoatomic ion from Groups 14 through 17 having a charge between −1 and −3 or a poly atomic ion having a charge between −1 and −3.

In the compound present in the aqueous composition as disclosed herein, monatomic constituents that can be employed as Z include Group 17 halides such as fluoride, chloride, iodide and bromide; Group 15 materials such as nitrides and phosphides and Group 16 materials such as oxides and sulfides. Polyatomic constituents include carbonate, hydrogen carbonate, chromate, cyanide, nitride, nitrate, permanganate, phosphate, sulfate, sulfite, chlorite, perchlorate, hydrobromite, bromite, bromate, iodide, hydrogen sulfate, hydrogen sulfite. It is contemplated that the composition of matter can be composed of a single one to the materials listed above or can be a combination of one or more of the compounds listed.

It is also contemplated that, in certain embodiments, x is an integer between 3 and 9, with x being an integer between 3 and 6 in some embodiments.

In certain embodiments, y is an integer between 1 and 10; while in other embodiments, y is an integer between 1 and 5.

In certain embodiments, the compound present in the aqueous process fluid can have the general formula:

$$⌊ {H}_{x} {O}_{\frac{( x - 1 )}{2}} ⌋ {Z}_{y}$$

x is an odd integer between 3 and 12;
y is an integer between 1 and 20; and
Z is one of a group 14 through 17 monoatomic ion having a charge between −1 and −3 or a poly atomic ion having a charge between −1 and −3 as outlined above, with some embodiments having x between 3 and 9 and y being an integer between 1 and 5.

It is contemplated that the composition of matter exists as an isomeric distribution in which the value x is an average distribution of integers greater than 3 favoring integers between 3 and 10.

When present in the aqueous process fluid as disclosed herein, the resulting solution can include a formula having the general formula:

$$[ {H}_{x} {O}_{\frac{( x - 1 )}{2}} ] +$$

wherein x is an odd integer ≥3.

It is contemplated that ionic version of the compound as disclosed herein exists in unique ion complexes that have greater than seven hydrogen atoms in each individual ion complex which are referred to in this disclosure as hydronium ion complexes. As used herein, the term “hydronium ion complex” can be broadly defined as the cluster of molecules that surround the cation HₓOₓ₋₁+ where x is an integer greater than or equal to 3. The hydronium ion complex may include at least four additional hydrogen molecules and a stoichiometric proportion of oxygen molecules complexed thereto as water molecules. Thus, the formulaic representation of non-limiting examples of the hydronium ion complexes that can be employed in the process herein can be depicted by the formula:

$$[ {H}_{x} {O}_{\frac{( x - 1 )}{2}} + {( {H}_{2} O )}_{y} ]$$

where x is an odd integer of 3 or greater; and
y is an integer from 1 to 20, with y being an integer between 3 and 9 in certain embodiments.

In such structures, an

$$[ {H}_{x} {O}_{\frac{( x - 1 )}{2}} ] + core is protonated by multiple {H}_{2} O$$

molecules. It is contemplated that the hydronium complexes present in the composition of matter as disclosed herein can exist as Eigen complex cations, Zundel complex cations or mixtures of the two. The Eigen solvation structure can have the hydronium ion at the center of an H₉O₄+ structure with the hydronium complex being strongly bonded to three neighboring water molecules. The Zundel solvation complex can be an H₅O₂+ complex in which the proton is shared equally by two water molecules. The solvation complexes typically exist in equilibrium between Eigen solvation structure and Zundel solvation structure. Heretofore, the respective solvation structure complexes generally existed in an equilibrium state that favors the Zundel solvation structure.

Without being bound to any theory, it is believed that stable materials can be produced in which hydronium ion exists in an equilibrium state that favors the Eigen complex. The present disclosure is also predicated on the unexpected discovery that increases in the concentration of the Eigen complex in a process stream can provide a class of novel enhanced oxygen-donor oxonium materials.

The aqueous process fluid as disclosed herein can have an Eigen solvation state to Zundel solvation state ratio between 1.2 to 1 and 15 to 1 in certain embodiments; with ratios between 1.2 to 1 and 5 to 1 in other embodiments.

It is contemplated that oxonium complexes discussed herein can include other materials employed by various processes. Non-limiting examples of general processes to produce hydrated hydronium ions are discussed in U.S. Pat. No. 5,830,838, the specification of which is incorporated by reference herein.

The compound as employed in the aqueous process fluid can have the chemical structure:

$$[ {H}_{x} {O}_{\frac{( x - 1 )}{2}} ] +$$

wherein x is an odd integer ≥3;
y is an integer between 1 and 20; and
Z is a polyatomic or monatomic ion.
In certain embodiments, the aqueous process fluid can have the following chemical structure:

$$[ {H}_{x} {O}_{\frac{( x - 1 )}{2}} + {( {H}_{2} O )}_{y} ] Z$$

wherein x is an odd integer between 3-11;
y is an integer between 1 and 10; and
Z is a polyatomic ion or monoatomic ion.

The polyatomic ion employed can be an ion derived from an acid having the ability to donate one or more protons. The associated acid can be one that would have a pKa values≥1.7 at 23° C. The ion employed can be one having a charge of +2 or greater. Non-limiting examples of such ions include sulfate, carbonate, phosphate, chromate, dichromate, pyrophosphate and mixtures thereof. In certain embodiments, it is contemplated that the polyatomic ion can be derived from mixtures that include polyatomic ion mixtures that include ions derived from acids having pKa values≤1.7.

In certain embodiments, the composition of matter is composed of a stiochiometrically balanced chemical composition of at least one of the following: hydrogen (1+), triaqua-μ3-oxotri sulfate (1:1); hydrogen (1+), triaqua-μ3-oxotri carbonate (1:1), hydrogen (1+), triaqua-μ3-oxotri phosphate, (1:1); hydrogen (1+), triaqua-μ3-oxotri oxalate (1:1); hydrogen (1+), triaqua-μ3-oxotri chromate (1:1) hydrogen (1+), triaqua-μ3-oxotri dichromate (1:1), hydrogen (1+), triaqua-μ3-oxotri pyrophosphate (1:1), and mixtures thereof.

Where desired or required, the compound present in the aqueous process fluid can be formed by the addition of a suitable inorganic hydroxide to a suitable inorganic acid. The inorganic acid may have a density between 22° and 70° baume; with specific gravities between about 1.18 and 1.93. In certain embodiments, it is contemplated that the inorganic acid will have a density between 50° and 67° baume; with specific gravities between 1.53 and 1.85. The inorganic acid can be either a monoatomic acid or a polyatomic acid.

The inorganic acid employed can be homogenous or can be a mixture of various acid compounds that fall within the defined parameters. It is also contemplated that the acid may be a mixture that includes one or more acid compounds that fall outside the contemplated parameters but in combination with other materials will provide an average acid composition value in the range specified. The inorganic acid or acids employed can be of any suitable grade or purity. In certain instances, tech grade and/or food grade material can be employed successfully in various applications.

In preparing the stable electrolyte material as disclosed herein, the inorganic acid can be contained in any suitable reaction vessel in liquid form at any suitable volume. In various embodiments, it is contemplated that the reaction vessel can be non-reactive beaker of suitable volume. The volume of acid employed can be as small as 50 ml. Larger volumes up to and including 5000 gallons or greater are also considered to be within the purview of this disclosure.

The inorganic acid can be maintained in the reaction vessel at a suitable temperature such as a temperature at or around ambient. It is within the purview of this disclosure to maintain the initial inorganic acid in a range between approximately 23° and about 70° C. However lower temperatures in the range of 15° and about 40° C. can also be employed.

The inorganic acid is agitated by suitable means to impart mechanical energy in a range between approximately 0.5 HP and 3 HP with agitation levels imparting mechanical energy between 1 and 2.5 HP being employed in certain applications of the process. Agitation can be imparted by a variety of suitable mechanical means including, but not limited to, DC servodrive, electric impeller, magnetic stirrer, chemical inductor and the like.

Agitation can commence at an interval immediately prior to hydroxide addition and can continue for an interval during at least a portion of the hydroxide introduction step.

In the process as disclosed herein, the acid material of choice may be a concentrated acid with an average molarity (M) of at least 7 or above. In certain procedures, the average molarity will be at least 10 or above; with an average molarity between 7 and 10 being useful in certain applications. The acid material of choice employed may exist as a pure liquid, a liquid slurry or as an aqueous solution of the dissolved acid in essentially concentrated form.

Suitable acid materials can be either aqueous or non-aqueous materials. Non-limiting examples of suitable acid materials can include one or more of the following: hydrochloric acid, nitric acid, phosphoric acid, chloric acid, perchloric acid, chromic acid, sulfuric acid, permanganoic acid, prussic acid, bromic acid, hydrobromic acid, hydrofluoric acid, iodic acid, fluoboric acid, fluosilicic acid, fluotitanic acid.

In certain embodiments, the defined volume of a liquid concentrated strong acid employed can be sulfuric acid having a specific gravity between 55° and 67° baume. This material can be placed in the reaction vessel and mechanically agitated at a temperature between 16° and 70° C.

In certain specific production methods, a measured, defined quantity of suitable hydroxide material can be added to an agitating acid, such as concentrated sulfuric acid, that is present in the non-reactive vessel in a measured, defined amount. The amount of hydroxide that is added will be that sufficient to produce a solid material that is present in the composition as a precipitate and/or a suspended solids or colloidal suspension. The hydroxide material employed can be a water-soluble or partially water-soluble inorganic hydroxide. Partially water-soluble hydroxides employed in the process as disclosed herein will generally be those which exhibit miscibility with the acid material to which they are added. Non-limiting examples of suitable partially water-soluble inorganic hydroxides will be those that exhibit at least 50% miscibility in the associated acid. The inorganic hydroxide can be either anhydrous or hydrated.

Non-limiting examples of water soluble inorganic hydroxides include water soluble alkali metal hydroxides, alkaline earth metal hydroxides and rare earth hydroxides; either alone or in combination with one another. Other hydroxides are also considered to be within the purview of this disclosure. “Water-solubility” as the term is defined in conjunction with the hydroxide material that will be employed is defined a material exhibiting dissolution characteristics of 75% or greater in water at standard temperature and pressure. The hydroxide that is utilized typically is a liquid material that can be introduced into the acid material. The hydroxide can be introduced as a true solution, a suspension or a super-saturated slurry. In certain embodiments, it is contemplated that the concentration of the inorganic hydroxide in aqueous solution can be dependent on the concentration of the associated acid to which it is introduced. Non-limiting examples of suitable concentrations for the hydroxide material are hydroxide concentrations greater than 5 to 50% of a 5 mole material.

Suitable hydroxide materials include, but are not limited to, lithium hydroxide, sodium hydroxide, potassium hydroxide, ammonium hydroxide, calcium hydroxide, strontium hydroxide, barium hydroxide, magnesium hydroxide, and/or silver hydroxide. Inorganic hydroxide solutions when employed may have concentration of inorganic hydroxide between 5 and 50% of a 5 mole material, with concentration between 5 and 20% being employed in certain applications. The inorganic hydroxide material, in certain processes, can be calcium hydroxide in a suitable aqueous solution such as is present as slaked lime.

In the process as disclosed, the inorganic hydroxide in liquid or fluid form is introduced into the agitating acid material in one or more metered volumes over a defined interval to provide a defined resonance time. The resonance time in the process as outlined is considered to be the time interval necessary to promote and provide the environment in which the hydronium ion material as disclosed herein develops. The resonance time interval as employed in the process as disclosed herein is typically between 12 and 120 hours with resonance time intervals between 24 and 72 hours and increments therein being utilized in certain applications.

In various applications of the process, the inorganic hydroxide is introduced into the acid at the upper surface of the agitating volume in a plurality of metered volumes. Typically, the total amount of inorganic hydroxide material will be introduced as a plurality of measured portions over the resonance time interval. Front-loaded metered addition being employed in many instances. “Front-loaded metered addition”, as the term is used herein, is taken to mean addition of the total hydroxide volume with a greater portion being added during the initial portion of the resonance time. An initial percentage of the desired resonance time -considered to be between the first 25% and 50% of the total resonance time.

It is to be understood that the proportion of each metered volume that is added can be equal or can vary based on such non-limiting factors as external process conditions, in situ process conditions, specific material characteristics, and the like. It is contemplated that the number of metered volumes can be between 3 and 12. The interval between additions of each metered volume can be between 5 and 60 minutes in certain applications of the process as disclosed. The actual addition interval can be between 60 minutes to five hours in certain applications.

In certain applications of the process, a 100 ml volume of 5% weight per volume of calcium hydroxide material is added to 50 ml of 66° baume concentrated sulfuric acid in 5 metered increments of 2 ml per minute, with or without admixture. Addition of the hydroxide material to the sulfuric acid produces a material having increasing liquid turbidity. Increasing liquid turbidity is indicative of calcium sulfate solids forming as precipitate. The produced calcium sulfate can be removed in a fashion that is coordinated with continued hydroxide addition in order to provide a coordinated concentration of suspended and dissolved solids.

Without being bound to any theory, it is believed that the addition of calcium hydroxide to sulfuric acid in the manner defined herein results in the consumption of the initial hydrogen proton or protons associated with the sulfuric acid resulting in hydrogen proton oxygenation such that the proton in question is not off-gassed as would be generally expected upon hydroxide addition. Instead, the proton or protons are recombined with ionic water molecule components present in the liquid material.

After the suitable resonance time as defined has passed, the resulting material is subjected to a non-bi-polar magnetic field at a value greater than 2000 gauss; with magnetic fields greater than 2 million gauss being employed in certain applications. It is contemplated that a magnetic field between 10,000 and 2 million gauss can be employed in certain situations. The magnetic field can be produced by various suitable means. One non-limiting example of a suitable magnetic field generator is found in U.S. Pat. No. 7,122,269 to Wurzburger, the specification of which is incorporated by reference herein.

Solid material generated during the process and present as precipitate or suspended solids can be removed by any suitable means. Such removal means include, but need not be limited to, the following: gravimetric, forced filtration, centrifuge, reverse osmosis and the like.

The material that is produced by this method is a shelf-stable viscous liquid that is believed to be stable for at least one year when stored at ambient temperature and between 50 to 75% relative humidity. The resulting material can be used neat in various end use applications. The material can have a 1.87 to 1.78 molar material that contains 8 to 9% of the total moles of acid protons that are not charged balanced. The resulting material that results from the process as disclosed herein has molarity of 200 to 150 M strength, and 187 to 178 M strength in certain instances, when measured titramtrically though hydrogen coulometery and via FFTIR spectral analysis. The material has a gravimetric range greater than 1.15; with ranges greater than 1.9 in in certain instances. The material, when analyzed, is shown to yield up to1300 volumetric times of orthohydrogen per cubic ml versus hydrogen contained in a mole of water. The resulting material can be admixed with sufficient water to produce the aqueous process fluid as disclosed herein. It is also contemplated that introduction of the resulting material into water will result in a solution having concentration of hydronium ions greater than 15% by volume. In some applications, the concentration of hydronium ions can be greater than 25% and it is contemplated that the concentration of hydronium ions can be between 15 and 50% by volume. In certain embodiments.

The method as disclosed here can also be employed to remove one or more ionically soluble organic compounds from association with the ion exchange material. The method for removing ionically soluble organic compounds from association with an ion exchange resin includes the steps of contacting the ion exchange material with an aqueous process fluid with an aqueous process fluid comprising a compound of the following general formula:

$$⌊ {H}_{x} {O}_{\frac{( x - 1 )}{2}} ⌋ {Z}_{y}$$

wherein x is an odd integer ≥3;
wherein y is an integer between 1 and 20; and
wherein Z is a polyatomic ion, a monoatomic ion, or a mixture of a polyatomic ion and a monoatomic ion, the contacting step proceeding for an interval sufficient to reduce the concentration of ionically soluble organic material associated with the ion exchange resin.

In certain embodiments, the present disclosure contemplates that the treatment of ion exchange resin will result in reduction of ionically soluble organic compounds associated with the ion exchange resin. This reduction can occur with or with a concomitant reduction in metal ions associated with the ion exchange. resin.

Non-limiting examples of ionically soluble organic compounds suitable for treatment by the method disclosed herein include at least one of the following: monofunctional carboxylic acids having five or less carbon atoms, monofunctional amines having six or less carbon atoms, monofunctional alcohols, monofunctional aldehydes. In certain embodiments the ionically soluble organic compound can be selected from the group consisting of acetaldehyde, acetic acid, acetone, acetonitrile, 1.2-butenediol, 1,3-butaediol, 1,4-butaediol, 2-butoxyethanol, butyric acid, diethanolamine, diethylenetriamine, dimethylformamide, dimethoxyethane, dimethyl sulfoxide, 1,4-dioxane, ethanol, ethylamine, ethylene glycol, formic acid, furfuryl alcohol, glycerol, methanol, methyl diethanolamine, methyl isocyanide, N-methyl-2-pyrrolidone, 1-propanol, 1,3-propanediol, 1,5-propanediol, 2-propanol, propanoic acid, propylene glycol, pyridine, tetrahydrofuran, triethylene glycol and mixtures thereof.

It is also contemplated that the method as disclosed herein can be employed to reduce or eliminate at least one water-borne pathogen that can be associated with the ion exchange material. In certain embodiments, the water-borne can be selected from the group consisting of protozoa, bacteria, viruses, algae, parasitic worms and mixtures thereof.

Non-limiting examples of water-borne pathogenic protozoa include at least one of the following: Acanthamoeba castelanii, Acanthamoeba polyphaga, Entamoeba histolytica, Cryptosporidium parvum, Cyclospora cayetanensis, Giardia lamblia, Microsporidia, Encephalitozoon intestinalis, Naegleria fowleri. In certain applications of the method as disclosed herein, the water-borne pathogenic protozoa is selected from the group consisting of Acanthamoeba castelanii, Acanthamoeba polyphaga, Entamoeba histolytica, Cryptosporidium parvum, Cyclospora cayetanensis, Giardia lamblia, Microsporidia, Encephalitozoon intestinalis, Naegleria fowleri and mixtures thereof.

Non-limiting examples of water-borne pathogenic bacterial include at least one of the following: Clotridium botulinum, Campylobacter jejuni, Vibrio cholerae, Escherichia coli, Mycobacterium marinum, Shegella dysenteriae, Shegella flexneri, Shegella boydii, Shegella sonnei, Salmonella typhi, Salmonella typhimurium, Salmonella enteritidis, Legionella pnuemophila, Leptospira, Vibrio vulnificus, Vibrio alginolyticus, Vibrio parahaemolyticus. In certain applications of the method as disclosed herein, the water-borne pathogenic bacteria is selected from the group consisting of Clotridium botulinum, Campylobacter jejuni, Vibrio cholerae, Escherichia coli, Mycobacterium marinum, Shegella dysenteriae, Shegella flexneri, Shegella boydii, Shegella sonnei, Salmonella typhi, Salmonella typhimurium, Salmonella enteritidis, Legionella pnuemophila, Leptospira, Vibrio vulnificus, Vibrio alginolyticus, Vibrio parahaemolyticus and mixtures thereof.

Non-limiting examples of water-borne pathogenic virus include at least one of the following: Coronavirus, Hepatis A virus, Hepatis E virus, Norovirus, Polyomavirae. In certain applications of the method as disclosed herein, the water-borne pathogenic bacteria is selected from the group consisting of Coronavirus, Hepatis A virus, Hepatis E virus, Norovirus, Polyomavirae and mixtures thereof.

Non-limiting examples of pathogenic water-borne algae include Desmodesmus armatus. Non-limiting examples of pathogenic water-borne parasitic worms include Dracunclus medinesis.

In order to better understand the invention disclosed herein, the following examples are presented. The examples are to be considered illustrative and are not to be viewed as limiting the scope of the present disclosure or claimed subject matter.

### EXAMPLE I

The active compound employed in the aqueous process fluid in the method disclosed herein is prepared by placing 50 ml of concentrated liquid sulfuric acid having a mass fraction H₂SO₄ of 98%, an average molarity(M) above 7 and a specific gravity of 66° baume in a non-reactive vessel and maintained at 25° C. with agitation by a magnetic stirrer to impart mechanical energy of 1 HP to the liquid.

Once agitation has commenced, a measured quantity of sodium hydroxide is added to the upper surface of the agitating acid material. The sodium hydroxide material employed is a 20% aqueous solution of 5M calcium hydroxide and is introduced in five metered volumes introduced at a rate of 2 ml per minute over an interval of five hours with to provide a resonance time of 24 hours. The introduction interval for each metered volume is 30 minutes.

Turbidity is produced with addition of calcium hydroxide to the sulfuric acid indicating formation of calcium sulfate solids. The solids are permitted to precipitate periodically during the process and the precipitate removed from contact with the reacting solution.

Upon completion of the 24-hour resonance time, the resulting material is exposed to a non-bi-polar magnetic field of 2400 gauss resulting in the production of observable precipitate and suspended solids for an interval of 2 hours. The resulting material is centrifuged and force filtered to isolate the precipitate and suspended solids.

### EXAMPLE II

The material produced in Example I is separated into individual samples. Some are stored in closed containers at standard temperature and 50% relative humidity to determine shelf-stability. Other samples are subjected to analytical procedures to determine composition. The test samples are subjected to FFTIR spectra analysis and titrated with hydrogen coulometry. The sample material has a molarity ranging from 187 to 178 M strength. The material has a gravimetric range greater than 1.15; with ranges greater than 1.9 in in certain instances. The composition is stable and has a 1.87 to 1.78 molar material that contains 8 to 9% of the total moles of acid protons that are not charged balanced. FFTIR analysis indicates that the material has the formula hydrogen (1+), triaqua-μ3-oxotri sulfate (1:1).

### EXAMPLE III

A 5 ml portion of the material produced according to the method outlined in Example I is admixed in a 5 ml portion of deionized and distilled water at standard temperature and pressure. The excess hydrogen ion concentration is measured as greater than 15% by volume and the pH of the material is determined to be 1.

### EXAMPLE IV

The process outlined in Examples I is scaled up to produce sufficient compound that, when admixed with water having a measure hardness level of 0 ppm yields an aqueous process fluid having a concentration of hydrogen (1+), triaqua-μ3-oxotri sulfate (1:1) of 15 vol. %. in an amount of 100 gallons.

### EXAMPLE V

Fifteen pounds of spent weakly acidic cation exchange ion exchange resin beads is isolated in a vessel to form a bed is and contacted with the composition of Example IV for an interval of two hours by continuously recirculating the aqueous process fluid through the resin bed at the end of the contact interval, the recirculating material is removed and analyzed. The recirculating material shows elevated levels of ionic calcium and magnesium.

### EXAMPLE VI

One hundred gallons of water having a hardness of 150 ppm is fed through the weakly acidic cation exchange resin beads as treated in Example V. The hardness of the water exiting the bed of weakly acidic cation exchange resin beads is measure and found be between 10 and 40 ppm.

### EXAMPLE VII

Multiple 15 ounce samples of weakly cationic exchange resin beads acidic beads arranges as beds are each inoculated with a pathogen as outlined in Table I. The initial pathogen load of each bed is determined and the respective beds are each contacted with the composition of Example IV. After contact the pathogen load of each bed is ascertained and demonstrates a pathogen load reduction of at least 95%.

TABLE I
Sample Pathogen

Cryptosporidium parvum
Cyclospora cayetanensis
Entamoeba histolytica
Clotridium botulinum
Escherichia coli
Mycobacterium marinum
Shegella dysenteriae
Salmonella enteritidis
Legionella pnuemophila
Coronavirus
Hepatis A virus
Hepatis E virus
Norovirus
desmodesmus armatus
dracunclus medinesis

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A system for treatment of water and regeneration of an ion exchange material employed in a water softening or conditioning system, the system comprising:
at least two treatment vessels, each treatment vessel having a housing, the housing having at least one water inlet and at least one water outlet and an interior cavity and an ion exchange material contained therein;
at least one controller in electronic communication with the at least two treatment vessels, the electronic controller configured to alternately direct supply water to be conditioned or an aqueous process fluid to a respective treatment vessel;
at least one first storage vessel system in fluid communication with the at least two treatment vessels, the at least one storage vessel system containing an aqueous process fluid comprising a compound having the general formula:
$$⌊ {H}_{x} {O}_{\frac{( x - 1 )}{2}} ⌋ {Z}_{y}$$
wherein x is an odd integer ≥3;
wherein y is an integer between 1 and 20; and
wherein Z is a polyatomic ion, a monoatomic ion, or a mixture of a polyatomic ion and a monoatomic ion; and
at least one second storage vessel system in fluid communication with the at least two treatment vessels, the at least one second storage vessel system including at least one supply water reservoir containing a volume of supply water.

2. The system of claim 1 wherein the ion exchange material is a weak acid cation resin containing carboxylic acid active sites.

3. The system of claim 2 wherein the aqueous process fluid further comprises a metal cheating agent, the metal cheating agent selected from the group consisting of sodium nitrate, potassium nitrate, sodium succinate, potassium succinate, aspartate, maleate, ethylenediamine tetraacetate, ethylene glycol tetraacetate, polymerized amino acids, 1,2-bis(o-aminophenoxy)ethane-N,N,N′,N′-tetraacetate, sulfonated polycarboxylate copolymers, polymethacrylate, and mixtures thereof.

4. The system of claim 1 wherein the ion exchange material is one of strong acid cation exchange resin or weak acid cation exchange resin,

5. The method of claim 4 wherein the ion exchange resin is one of a membrane or bead-shaped material.

6. The system of claim 1 wherein the compound in the process fluid is one in which Z is one of a monoatomic ion from Groups 14 through 17 having a charge value between −1 and −3 or a polyatomic ion having a charge between −1 and −3.

7. The system of claim 6 wherein the polyatomic ion in the compound in the aqueous solution or dispersion has a charge of −2 or greater.

8. The system of claim 7 wherein Z is selected from the group consisting of sulfate, carbonate, phosphate, oxalate, chromate, dichromate, pyrophosphate and mixtures thereof.

9. The system of claim 1 wherein the compound in the aqueous process fluid is astiochiometrically balanced chemical composition of at least one of the following: hydrogen (1+), triaqua-μ3-oxotri sulfate (1:1); hydrogen (1+), triaqua-μ3-oxotri carbonate (1:1), hydrogen (1+), triaqua-μ3-oxotri phosphate, (1:1); hydrogen (1+), triaqua-μ3-oxotri oxalate (1:1); hydrogen (1+), triaqua-μ3-oxotri chromate (1:1) hydrogen (1+), triaqua-μ3-oxotri dichromate (1:1), hydrogen (1+), triaqua-μ3-oxotri pyrophosphate (1:1), and mixtures thereof.

10. The method of claim 9 wherein the aqueous process fluid further comprises a metal cheating agent, the metal cheating agent selected from the group consisting of sodium nitrate, potassium nitrate, sodium succinate, potassium succinate, aspartate, maleate, ethylenediamine tetraacetate, ethylene glycol tetraacetate, polymerized amino acids, 1,2-bis(o-aminophenoxy)ethane-N,N,N′,N′-tetraacetate, sulfonated polycarboxylate copolymers, polymethacrylate, and mixtures thereof.

11. The method of claim 1 wherein the target material that is removed includes metal ions that have been extracted from the hard water and are associated with the ion exchange material.

12. The method of claim 11 wherein the metal ions extracted include at least one of magnesium ions, calcium ions or mixtures of magnesium ions and calcium ions.

13. The method of claim 12 wherein at least a portion of the metal ions associated with the ion exchange resin are replaced with the polyatomic ion, monoatomic ion or mixture of polyatomic ion and monoatomic ion Z_{y}.

14. The method of claim 1 wherein the target material that is removed includes ionically soluble organic compounds.

15. The method of claim 14 wherein the ionically soluble organic compounds include at least one of monofunctional carboxylic acids having five or less carbon atoms, monofunctional amines having six or less carbon atoms, monofunctional alcohols, monofunctional aldehydes.

16. The method of claim 15 wherein the ionically soluble organic compound is selected from the group consisting of acetaldehyde, acetic acid, acetone, acetonitrile, 1.2-butenediol, 1,3-butaediol, 1,4-butaediol, 2-butoxyethanol, butyric acid, diethanolamine, diethylenetriamine, dimethylformamide, dimethoxyethane, dimethyl sulfoxide, 1,4-dioxane, ethanol, ethylamine, ethylene glycol, formic acid, furfuryl alcohol, glycerol, methanol, methyl diethanolamine, methyl isocyanide, N-methyl-2-pyrrolidone, 1-propanol, 1,3-propanediol, 1,5-propanediol, 2-propanol, propanoic acid, propylene glycol, pyridine, tetrahydrofuran, triethylene glycol and mixtures thereof.

17. The method of claim 1 wherein target compound to be removed is at least one active water-borne pathogen, wherein the at least one the active water-borne pathogen is selected from the group consisting of protozoa, bacteria, viruses, algae, parasitic worms and mixtures thereof.

18. The method of claim 17 wherein the protozoa is at least one of the following: Acanthamoeba castelanii, Acanthamoeba polyphaga, Entamoeba histolytica, Cryptosporidium parvum, Cyclospora cayetanensis, Giardia lamblia, Microsporidia, Encephalitozoon intestinalis, Naegleria fowleri.

19. The method of claim 18 wherein the bacteria is at least one of the following: Clotridium botulinum, Campylobacter jejuni, Vibrio cholerae, Escherichia coli, Mycobacterium marinum, Shegella dysenteriae, Shegella flexneri, Shegella boydii, Shegella sonnei, Salmonella typhi, Salmonella typhimurium, Salmonella enteritidis, Legionella pnuemophila, Leptospira, Vibrio vulnificus, Vibrio alginolyticus, Vibrio parahaemolyticus.

20. The method of claim 18 wherein the virus is at least one of the following: Coronavirus, Hepatis A virus, Hepatis E virus, Norovirus, Polyomavirae.

21. The method of claim 18 wherein the algae is Desmodesmus armatus.

22. The method of claim 18 wherein the parasitic worm is Dracunclus medinesis.

23. A method for regeneration of an ion exchange material in a waster softening system, the method comprising:
contacting the ion exchange material with an aqueous solution or dispersion to yield a regenerated ion exchange material, wherein the ion exchange material comprises at least one of metal ions, ionically soluble organic compounds, active water borne pathogens that have been extracted from a source of hard water, and wherein the aqueous solution or dispersion comprises a compound having the general formula:
$$[ {H}_{x} {O}_{\frac{( x - 1 )}{2}} + {( {H}_{2} O )}_{y} ] Z$$
wherein x is an odd integer greater than or equal to 3;
wherein y is an integer between 1 and 20; and
wherein Z is one of a monoatomic ion from Groups 14 through 17 having a charge value between −1 and −3 or a polyatomic ion having a charge between −1 and −3;
during the contacting step, at least a portion of the metal ions that have been extracted from the hard water present in the ion exchange material, the method taking place the system of claim 1.

24. The method of claim 23 wherein the aqueous solution further comprises a metal cheating agent, the metal cheating agent selected from the group consisting of sodium nitrate, potassium nitrate, sodium succinate, potassium succinate, aspartate, maleate, ethylenediamine tetraacetate, ethylene glycol tetraacetate, polymerized amino acids, 1,2-bis(o-aminophenoxy)ethane-N,N,N′,N′-tetraacetate, sulfonated polycarboxylate copolymers, polymethacrylate, and mixtures thereof.
